(19) United States
(12) Patent Application Publication
(10) Pub. No.: US 2004/0008306 A1
(43) Pub. Date: Jan. 15, 2004

(54) Optical compensator with surfactant addenda and process

(75) Inventors: Joseph W. Hoff, Fairport, NY (US); Richard A. Castle, Webster, NY (US); Jason A. Payne, Rochester, NY (US); James F. Elman, Fairport, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/195,093

(22) Filed: Jul. 12, 2002

(51) Int. Cl. G02F 1/1335

(52) U.S. Cl. 349/117

(57) ABSTRACT

Disclosed is an optical compensator and process for liquid crystal displays comprising a transparent polymeric support, an orientation layer, and an optically anisotropic layer, in order, wherein the anisotropic layer contains a surfactant. The uniformity and quality of this film is enhanced by the use of a surfactant in the optical anisotropic layer.

### CROSS-REFERENCE TO RELATED APPLICATIONS

This application is cofiled as part of a group of the following commonly assigned applications under Attorney Docket Nos. 84732, 84733, 84735, 84736, 84760, 84833, 84839, and 84864, the contents of which are incorporated herein by reference.

### FIELD OF THE INVENTION

This invention relates to an optical compensator for improving viewing angle characteristics of liquid crystal displays having a substrate, an orientation layer, and an optical anisotropic layer containing a surfactant.

### BACKGROUND OF THE INVENTION

Current rapid expansion in the liquid crystal display (LCD) applications in various areas of information display is largely due to improvements of display qualities. Contrast, color reproduction, and stable gray scale intensities are important quality attributes for electronic displays, which employ liquid crystal technology. The primary factor limiting the contrast of a liquid crystal display is the propensity for light to “leak” through liquid crystal elements or cell, which are in the dark or “black” pixel state. Furthermore, the leakage and hence contrast of a liquid crystal display are also dependent on the angle from which the display screen is viewed. Typically the optimum contrast is observed only within a narrow viewing angle centered about the normal incidence to the display and falls off rapidly as the viewing angle is increased. In color displays, the leakage problem not only degrades the contrast but also causes color or hue shifts with an associated degradation of color reproduction. In addition to black-state light leakage, the narrow viewing angle problem in typical twisted nematic liquid crystal displays is exacerbated by a shift in the brightness-voltage curve as a function of viewing angle because of the optical anisotropy of the liquid crystal material.

Thus, one of the major factors measuring the quality of such displays is the viewing angle characteristic, which describes a change in contrast ratio from different viewing angles. It is desirable to be able to see the same image from a wide variation in viewing angles and this ability has been a shortcoming with liquid crystal display devices. One way to improve the viewing angle characteristic is to insert a compensator (also referred as compensation film, retardation film, or retarder) with proper optical properties between the polarizer and liquid crystal cell, such as disclosed in U.S. Pat. No. 5,583,679 (Ito et al.), U.S. Pat. No. 5,853,801 (Suga et al.), U.S. Pat. No. 5,619,352 (Koch et al.), U.S. Pat. No. 5,978,055 (Van De Witte et al.), and U.S. Pat. No. 6,160,597 (Schadt et al.). A compensation film according to U.S. Pat. No. 5,583,679 (Ito et al.) and U.S. Pat. No. 5,853,801 (Suga et al.), based on discotic liquid crystals which have negative birefringence, is widely used. It offers improved contrast over wider viewing angles, however, it suffers larger color shift for gray level images, compared to a compensator made of liquid crystalline materials with positive birefringence, according to Satoh et al. (“Comparison of nematic hybrid and discotic hybrid films as viewing angle compensator for NW-TN-LCDs”, SID 2000 Digest, pp. 347-349, (2000)). To achieve comparable performance in the contrast ratio while reducing color shift, one alternative is to use a pair of crossed liquid crystal polymer films (LCP) on each side of liquid crystal cell, as discussed by Chen et al. (“Wide Viewing Angle Photoaligned Plastic Films”, SID 99 Digest, pp.98-101 (1999)). This paper states that “since the second LPP/LCP retarder film is coated directly on top of the first LCP retarder film, the total thickness of the final wide-view retarder stack is only a few microns thin”. Although they provide very compact optical component, one of the challenges of this method is to make two LCP layers crossed, particularly in a continuous roll to roll manufacturing process.

The compensating films are prepared by coating the LPP/LCP materials from organic solvents onto a transparent substrate. The Theological properties of the LPP/LCP materials in organic solvents, coupled with the thin nature of the applied materials when in the liquid state on the substrate, leave the coated materials susceptible to post-application imperfections which include, but are not limited to, mottle, drying convection cells, and repellencies. These post-application imperfections can cause spatial variations in the thickness of the thin film when in its final cured state. These variations in thickness will result in localized contrast variations when the compensating film is viewed through crossed-polarizers, or more importantly, when used in a full LCD cell.

U.S. Pat. No. 5,583,679 discloses the addition of surface active agents (i.e., surfactants) to optical anisotropic layers containing discotic liquid crystal compounds in order to change the tilt angle (also referred to as the incline angle) of the discotic liquid crystalline compound.

It is a problem to be solved to provide an optical compensator that widens the viewing angle characteristics of liquid crystal displays, in particular Twisted Nematic (TN), Super Twisted Nematic (STN), Optically Compensated Bend (OCB), In Plane Switching (IPS), or Vertically Aligned (VA) liquid crystal displays, is readily manufactured, and has coated layers having improved uniform spatial thickness. These various liquid crystal display technologies have been reviewed in U.S. Pat. No. 5,619,352 (Koch et al.), U.S. Pat. No. 5,410,422 (Bos), and U.S. Pat. No. 4,701,028 (Clerc et al.).

### SUMMARY OF THE INVENTION

The invention provides an optical compensator and process for liquid crystal displays comprising a transparent polymeric support, an orientation layer, and an optically anisotropic layer, in order, wherein the anisotropic layer contains a surfactant. The uniformity and quality of this film is enhanced by the use of an optical anisotropic layer containing a surfactant. Contrary to the prior art the addition of such materials does not change the tilt angle of the liquid crystalline layer in the optical compensation film.

The optical compensator of the present invention widens the viewing angle characteristics of liquid crystal displays, and in particular of Twisted Nematic (TN), Super Twisted Nematic (STN), Optically Compensated Bend (OCB), In Plane Switching (IPS), or Vertically Aligned (VA) liquid crystal displays, is readily manufactured in a roll-to-roll coatable process with excellent layer uniformities and optical properties.

### BRIEF DESCRIPTION OF THE DRAWINGS

FIG. 1 is a cross-sectional schematic view of a compensator of the present invention.

FIGS. 2A and 2B are cross-sectional schematic views of various embodiments of the present invention.

FIG. 3 is a schematic concept in accordance with the present invention.

FIG. 4 shows a liquid crystal display in combination with a compensator according to the present invention.

FIG. 5 shows a roll-to-roll process for making a compensator according to the present invention.

### DETAILED DESCRIPTION OF THE INVENTION

The current invention regarding the optical compensator for liquid crystal displays is described by referring to the drawings as follows.

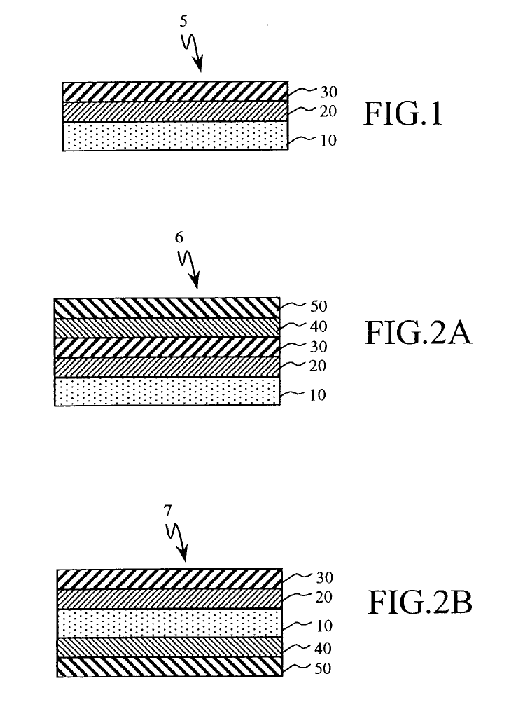

FIG. 1 shows a cross-sectional schematic view of an optical compensator 5 according to the present invention. This compensator comprises a substrate 10 of transparent material, such as glass or polymer. It should be understood that to be called as a substrate, a layer must be solid and mechanically strong so that it can stand alone and support other layers. A typical substrate is made of triacetate cellulose (TAC), polyester, polycarbonate, polysulfone, polyethersulfone, or other transparent polymers, and has a thickness of 25 to 500 micrometers. Substrate 10 typically has low in-plane retardation, preferably less than 10 nm, and more preferably less than 5 nm. In some other cases, the substrate 10 may have larger in-plane retardation between 15 to 150 nm. Typically, when the substrate 10 is made of triacetyl cellulose, it has out-of-plane retardation around −40 nm to −120 nm. This is a desired property when the compensator is designed to compensate a liquid crystal state with an ON voltage applied. The in-plane retardation discussed above is defined as the absolute value of (nx−ny)d and the out-of-plane retardation discussed above is defined as [(nx+ny)/2−nz]d, respectively. The refractive indices nx and ny are along the slow and fast axes in plane of the substrate, respectively, nz is the refractive index along the substrate thickness direction (Z-axis), and d is the substrate thickness. The substrate is preferably in the form of a continuous (rolled) film or web.

On the substrate 10, an orientation layer 20 is applied, and an anisotropic layer 30 is disposed on top of layer 20. If desired, auxiliary layers between the substrate and orientation may be used to improve adhesion, or provide barrier properties to prevent intermixing or interdiffusion of materials between the substrate and the orientation layer.

The orientation layer 20 can be oriented by various techniques one example, the orientation layer contains a rubbing-orientable material such as a polyimide or polyvinyl alcohol and can be oriented by a rubbing technique. In another example, the orientation layer contains a shear-orientable material and can be oriented by a shear-alignment technique. In another example, the orientation layer contains an electrically- or magnetically-orientable material and can be oriented by an electrical- or magnetic-alignment technique. In another example, the orientation layer can also be a layer of SiOx fabricated by oblique deposition. In another example, the orientation layer contains a photo-orientable material and can be oriented by a photo-alignment technique. Photo-orientable materials include, for example, photo isomerization polymers, photo dimerization polymers, and photo decomposition polymers. In a preferred embodiment, the photo-orientable materials are cinnamic acid derivatives as disclosed in U.S. Pat. No. 6,160,597. Such materials may be oriented and simultaneously crosslinked by selective irradiation with linear polarized UV light.

The anisotropic layer 30 is typically a liquid crystalline monomer when it is first disposed on the orientation layer 20, and is cross-linked by a further UV irradiation, or polymerized by other means such as heat. In a preferred embodiment, the anisotropic layer contains a material such as a diacrylate or diepoxide with positive birefringence as disclosed in U.S. Pat. No. 6,160,597 (Schadt et al.) and U.S. Pat. No. 5,602,661 (Schadt et al.). In another embodiment, the anisotropic layer contains a material with negative birefringence, such as a discotic liquid crystal disclosed in U.S. Pat. No. 5,583,679 (Ito et al.). The optic axis in the anisotropic layer 30 is usually tilted relative to the layer plane, and varies across the thickness direction.

The anisotropic layer 30 in accordance with the present invention also contains a surfactant. Surfactants useful in the layer include, but are not limited to: fluorinated surfactants including polymeric fluorochemicals such as fluoro(meth)acrylate polymers; fluorotelomers such as those having the structure R_{f}CH₂CH₂OOC—C₁₇H₃₅ or (R_{f}CH₂CH₂OOC)₃C₃H₅O, wherein R_{f} is CF₃CF₂(CF₂CF₂)_{x=2 to 4}, ethoxylated nonionic fluorochemicals such as those having the general structure RfCH₂CH₂O(CH₂CH₂O)_{y}H, wherein Rf is CF₃CF₂(CF₂CF₂)_{x=2 to 4}, and fluorosilcones; silicone surfactants such as polysiloxanes; polyoxyethylene-lauryl ether surfactants; sorbitan laurate; palmitate; and stearates.

Preferred surfactants for use in the present invention are fluorinated surfactants. Such surfactants are preferred due to their effectiveness at very low concentrations and their chemical and thermal stabilities. Particularly preferred fluorinated surfactants are polymeric fluorochemicals, such as fluoro(meth)acrylates, and ethoxylated nonionic fluorochemicals. Non-limiting commercially-available examples of fluoro(meth)acrylates include Zonyl FSG (DuPont) and Modiper F-2020 (NOF Corporation). Non-limiting commercially-available examples of ethoxylated nonionic fluorochemicals include Zonyl FSN and Zonyl FSO (DuPont).

The concentration of the surfactant can vary depending on the coating method for applying the anisotropic layer, and the concentration is based on the amount of coating solution applied to the substrate. Preferred concentrations of the surfactant are 0.001% to 0.1% by weight of the coating solution. Typically in the dried film, this corresponds to a range from 0.001% to 1.0 wt % depending on the coating method employed. Most preferred are surfactant concentrations between 0.01% and 0.05% by weight of the coating solution. Typically in the dried film, this corresponds to a range from 0.01% to 1.0 wt % depending on the coating method employed. The anisotropic layer of the invention may contain one surfactant or a mixture of different surfactants.

The anisotropic layer may also contain addenda such as surfactants, light stabilizers and UV initiators. UV initiatiors include materials such as benzophenone and acetophenone and their derivatives; benzoin, benzoin ethers, benzil, benzil ketals, fluorenone, xanthanone, alpha and beta naphthyl carbonyl compounds and ketones. Preferred initiators are alpha-hydroxyketones.

While this type of compensator described above provides some desired optical properties, it is not sufficient in many applications, for example, as a compensator for Twisted Nematic (TN) Liquid Crystal Displays (LCDs).

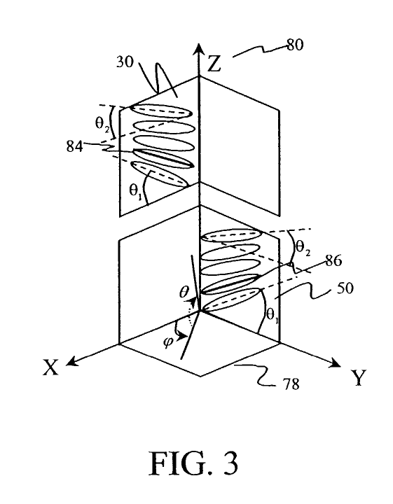

FIG. 2A illustrates a more sophisticated optical compensator 6 of the invention that contains a second orientation layer 40 and a second anisotropic layer 50 on top of the first anisotropic layer 30. The second orientation layer 40 and the second anisotropic layer 50 are made essentially in the same way as the first orientation layer 20 and the first anisotropic layer 30 are made, except that the direction of the orientation may vary. For the purpose of illustration, refer to an XYZ coordinate system 80 as shown in FIG. 3. The X and Y axes are parallel to the plane of substrate 78, and the Z-axis is perpendicular to the plane of substrate 78. The angle φ is measured from the X-axis in the XY plane, and referred as an azimuthal angle. The angle θ is measured from the XY plane, and referred as a tilt angle.

It should be understood that the optic axis in each of the anisotropic layers 30 and 50 can have a variable tilt angle and/or variable azimuthal angle. For example, the optic axis 84 in the anisotropic layer 30 has a variable tilt angle θ across the Z-axis ranging from θ₁ to θ₂. In another example, the optic axis 84 has a fixed tilt angle θ across the Z-axis, namely, θ₁=θ₂. In another example, the optic axis 84 is contained in one plane such as the XZ plane and consequently has a fixed azimuthal angle φ across the Z-axis. In another example, although the anisotropic layer 30 is still oriented along the preferred direction forced by the orientation layer at their interface, the optic axis 84 has a variable azimuthal angle φ across the Z-axis. The azimuthal angle of the optic axis 84 can be varied by adding a proper amount of chiral dopant into the anisotropic layer 30. In another example, the optic axis 84 has a variable tilt angle θ and a variable azimuthal angle φ across the Z-axis. Like the optic axis 84 of the anisotropic layer 30, the optic axis 86 of the anisotropic layer 50 can also have a fixed tilt angle, a variable tilt angle, a fixed azimuthal angle, a variable azimuthal angle, or a variable tilt angle and a variable azimuthal angle across the Z-axis. The anisotropic layers 30 and 50 typically have different optic axis. Preferably the anisotropic layer 30 is positioned orthogonally relative to the respective optic axis of the anisotropic layer 50 about an axis perpendicular to the plane of the substrate. Even though the optic axis of the anisotropic layer 30 is preferred to be orthogonal (or ±90 degrees) relative to the respective (or counterpart) optic axis of the anisotropic layer 50 about an axis perpendicular to the plane of the substrate, it should be understood that the angle between the optic axis of the two anisotropic layers can be in a range of 85 to 95 degrees to be considered as orthogonal.

For the manufacture of more complex layer structures than that illustrated in FIG. 2A, additional orientation and anisotropic layers can be applied in further steps.

FIG. 2B illustrates another optical compensator 7 of the invention in which the second orientation layer 40 and the second anisotropic layer 50 are on the opposite side of the substrate from the first orientation layer 20 and the first anisotropic layer 30.

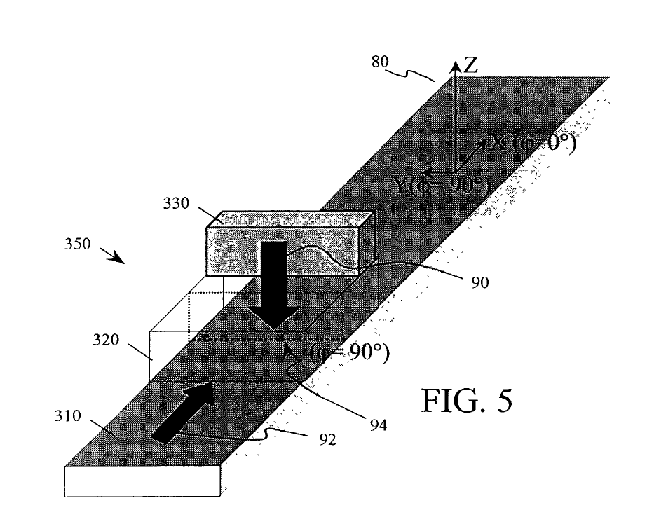

FIG. 5 shows another aspect of the present invention. A compensator 350 can be manufactured on a continuous roll-to-roll basis as shown in FIG. 5 which shows part of a schematic view of the process. The roll-to-roll process of forming a compensator 350 comprises the steps of applying a photo-alignable orientation layer 320, for example by coating by any known method such as extrusion hopper coating, roll-coating, slide hopper coating, or curtain coating, the orientable material in a solvent, onto a moving substrate 310, drying the orientation layer 320, photo-aligning (orienting) the orientation layer 320 in a predetermined alignment direction φ 94, (for the purpose of illustration φ=90°) relative to the roll moving direction 92, coating (as described earlier) an anisotropic layer 330 comprising a polymerizable material in a solvent carrier onto the orientation layer 320, drying the anisotropic layer 330, polymerizing the anisotropic layer 330 to form a continuous web of compensator. Note that for clarity, FIG. 5 only shows part of the orientation layer 320 and anisotropic layer 330.

In one embodiment, the orientation layer is oriented by rubbing the orientation layer in a direction 94 of 90 degrees (φ=90°) relative to the roll moving direction 92. In another embodiment, the orientation layer is oriented by a photo-alignment technique, for example, the orientation layer is exposed to a linearly polarized ultraviolet (UV) light indicated by 90. It may or may not be collimated, however, the projection (pointing along 94) of the principal ray of the light 90 onto the roll makes an angle of about 90 degrees relative to the roll moving direction.

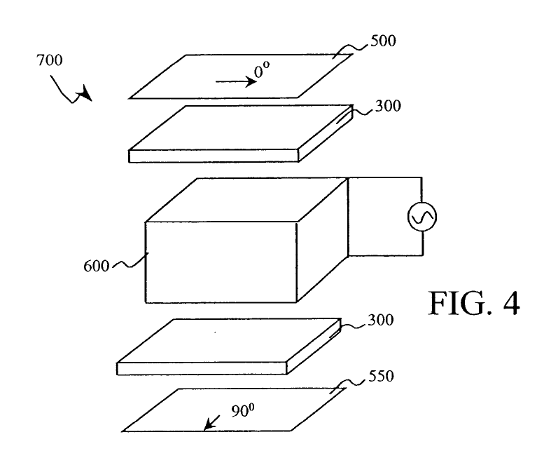

FIG. 4 is a schematic view of a liquid crystal display 700 comprising the compensator 300 in accordance with the present invention. In FIG. 4B, one compensator 300 is placed between the first polarizer 500 and the liquid crystal cell 600, and another compensator 300 is placed between a second polarizer 550 and the liquid crystal cell 600. The liquid crystal cell 600 is preferred to be operated in a Twisted Nematic (TN), Super Twisted Nematic (STN), Optically Compensated Bend (OCB), In Plane Switching (IPS), or Vertically Aligned (VA) mode. The polarizers 550 and 500 can be arranged crossed or parallel depending on the operation principles of the liquid crystal cell. The orientation layer in the compensator can be arranged parallel, perpendicular, or at a predetermined angle relative to the first polarizer 500. The liquid crystal cell can also be operated in a reflective mode, in which it may only require one polarizer.

The invention may be used in conjunction with electronic imaging device comprising a liquid crystal display device. The energy required to achieve this control is generally much less than that required for the luminescent materials used in other display types such as cathode ray tubes. Accordingly, liquid crystal technology is used for a number of applications, including but not limited to digital watches, calculators, portable computers, electronic games for which light weight, low power consumption and long operating life are important features.

The present invention is illustrated in more detail by the following non-limiting examples.

### EXAMPLE 1

Experimentation was performed to investigate the effect of surfactants on the spatial thickness uniformity of coated layers. To prepare samples, first a triacetyl cellulose (TAC) support was coated with a subbing solution of the following composition:

70.16% acetone

27.17% methanol

1.31% water

0.15% isopropanol

0.35% cellulose nitrate

0.71% gelatin

0.14% salicylic acid

This solution was applied to the TAC support at a wet coverage of 18.3 g/m² and dried. To this was applied a layer of gelatin at 2.2 g/m² dry coverage.

On top of the gelatin coated TAC, a photoalignment layer was coated from the following solution at a wet coverage of 16.5 g/m²: 23.30% Staralign 2110MEK (2% active, polyvinyl cinnamate polymer), from Vantico:

13.95% methyl ethyl ketone

22.75% cyclohexanone

40.00% n-propyl acetate

After drying to remove solvents, the sample was exposed to linearly polarized UVB light at a 20 degree angle. Upon this package of layers, a series of solutions of a crosslinkable diacrylate nematic liquid crystal material and a surfactant were coated at a wet coverage of 9.33 g/m², dried and exposed to 400 mJ/cm² of UVA light to crosslink the liquid crystal layer. The base diacrylate nematic liquid crystal solution without the additional surfactant is as follows:

29.00% LCP CB483MEK (30% active, diacrylate nematic liquid crystal) from Vantico

62.00% Toluene

9.00% ethyl acetate

Samples 1 through 7 in Table 1 below detail the surfactant employed and the results obtained. Each sample was then viewed between crossed polarizing filters to determine the effect of the surfactant on the resulting dried anisotropic layer uniformity, and a visual rating was assigned. The rating considered all obvious post-application imperfections, including mottle, drying convection cells, and repellencies. A rating of 1 corresponds to the poorest possible quality and a rating of 10 the best possible quality. The tilt angle of the anisotropic layer was measured by ellipsometry (J. A. Woollam Co., Model M2000V). The measured average tilt angle method had errors of ±2.0 degrees.

The following commercially-available surfactants were used in the examples.

S1: Modiper F-600, a fluoro(meth)acrylate polymer surfactant available from NOF Corp.

S2: Silwet L-7001, a polysiloxane surfactant available from Crompton Corp.

S3: Zonyl FSG, a fluoro(meth)acrylate polymer surfactant available from DuPont

S4: Modiper F-2020, a fluoro(meth)acrylate polymer surfactant available from NOF Corp.

S5: Surflon S-8405, a a fluoro(meth)acrylate polymer surfactant available from Semi Chemical Co.

S6: 3M L-16218B, a proprietary fluorochemical surfactant available from 3M Corp.

TABLE 1

| Sample Number | Surfactant | Concentration | Rating | Tilt Angle |
|---|---|---|---|---|
| 1 | No Surfactant | 0.0% | 1 | * |
| 2 | S1 | 0.02% | 4 | 7 |
| 3 | S2 | 0.02% | 4 | NA |
| 4 | S3 | 0.02% | 6 | 5 |
| 5 | S4 | 0.02% | 7 | 6 |
| 6 | S5 | 0.02% | 7 | NA |
| 7 | S6 | 0.02% | 9 | 7 |

* could not take accurate measurement due to poor coating quality
NA = not available

The results of Example 1 demonstrate the utility of the invention in that the inclusion of the surfactant in all cases (samples 2 through 7) improved the coated layer quality as compared to sample 1 in which no surfactant was present. The large improvement in coating quality was unexpected, especially in view of the small amount of surfactant used. Organic solvent-based coatings have very low surface tensions, and it is not normally expected that a coating surfactant will greatly lower the surface tension of the coating solution.

### EXAMPLE 2

A thin film package was prepared in the same manner as discussed in Example 1. A series of LCP solutions were prepared and surfactants as specified in sample 2 and sample 4 above were added into the different base solutions at a plurality of concentrations. Furthermore, a solution was prepared that contained no surfactant as per sample 1. Each solution was then coated and the resulting sample was visually rated using the method outlined in Example 1. A listing of the different surfactant concentrations at which the samples were coated and the results obtained are shown in Table 2 below

TABLE 2

| Sample | Concentration & Surfactant | Rating |
|---|---|---|
| 1 | No surfactant | 1 |
| 2 | 0.01% S1 | 2 |
| 3 | 0.02% S1 | 4 |
| 4 | 0.03% S1 | 5 |
| 5 | 0.05% S1 | 3 |
| 6 | 0.01% S3 | 5 |
| 7 | 0.02% S3 | 6 |
| 8 | 0.03% S3 | 3 |
| 9 | 0.05% S3 | 2 |

The results in Table 2 illustrate that performance is dependent not only on the surfactant selected, but also on the concentration of the surfactant in the LCP material.

The entire contents of the patents and other publications referred to in this specification are incorporated herein by reference.

### PARTS LIST

5 compensator according to the present invention

6 compensator according to the present invention

7 compensator according to the present invention

10 substrate

20 orientation layer

30 anisotropic layer

40 orientation layer

50 anisotropic layer

78 plane of substrate (or XY plane)

80 XYZ coordinate system

84 optic axis in the anisotropic layer 30

86 optic axis in the anisotropic layer 50

90 UV light

92 roll moving direction

94 alignment direction

300 compensator according to the present invention

310 moving substrate

320 orientation layer

330 anisotropic layer

350 compensator according to the present invention

500 polarizer

550 polarizer

600 liquid crystal cell

700 liquid crystal display

θ tilt angle

φ azimuthal angle

What is claimed is:

1. An optical compensator for a liquid crystal display comprising a transparent polymeric support, an orientation layer, and an optically anisotropic layer, in order, wherein the anisotropic layer contains a surfactant.

2. The compensator of claim 1 wherein the surfactant is present in an amount of 0.001 to 3.0 wt % of the anisotropic layer.

3. The compensator of claim 2 wherein the surfactant is present in an amount of 0.01 to 1.5 wt % of the anisotropic layer.

4. The compensator of claim 1 wherein the surfactant is a cationic surfactant.

5. The compensator of claim 1 wherein the surfactant is an anionic surfactant.

6. The compensator of claim 1 wherein the surfactant is a nonionic surfactant.

7. The compensator of claim 1 wherein the surfactant comprises a moiety selected from fluoride, silicone, polyalkylene oxide, fatty acid salts and esters.

8. The compensator of claim 1 wherein the surfactant is a fluorinated surfactant.

9. The compensator of claim 8 wherein the surfactant is present in the anisotropic layer in an amount of from 0.001% to 1.0 wt %.

10. The compensator of claim 8 wherein the surfactant is present in the anisotropic layer in an amount of from 0.01% to 1.0 wt %.

11. The compensator of claim 10 wherein the fluorinated contains a perfluorinated alkylene segment.

12. The compensator of claim 11 wherein the perfluorinated alkylene segment is form 6 to 10 carbons in length.

13. The compensator of claim 10 wherein the surfactant contains a fluoro(meth)acrylate polymer moiety.

14. The compensator of claim 1 wherein the surfactant contains a silicone moiety.

15. The compensator of claim 1 wherein the surfactant contains a fatty acid salt or ester moiety.

16. The compensator of claim 1 wherein said transparent support comprises a cellulose ester.

17. The compensator of claim 1 wherein said transparent support comprises a polycarbonate.

18. The compensator of claim 1 wherein the orientation layer is capable of orientation through photoalignment using polarized light.

19. The compensator of claim 18 wherein the orientation layer layer comprises a polyvinyl cinnamate.

20. The compensator of claim 1 wherein said optically anisotropic layer comprises a nematic liquid crystal.

21. The compensator of claim 3 wherein the nematic liquid crystal is a UV crosslinked material.

22. A liquid crystal display comprising a compensator of claim 1.

23. A process for preparing a compensator for a liquid crystal display comprising providing a transparent support, coating an orientation layer from an organic solvent over the support and then drying and aligning the orientation layer, and then coating and polymerizing an anisotropic liquid crystal layer comprising a polymerizable material and a surfactant in a solvent carrier over the orientation layer.

24. The process of claim 23 wherein the anisotropic coating contains 0.001 to 0.1 wt % of the surfactant.

25. A process for making an optical compensator, comprising the steps of:
a) coating an orientation layer comprising a photo-alignable polymer in a solvent over a transparent support;
b) drying the orientation layer;
c) photo-aligning the orientation layer in a predetermined direction;
d) coating an anisotropic liquid crystal layer comprising a polymerizable material and a surfactant in a solvent carrier over the orientation layer;
e) drying the anisotropic layer;
f) polymerizing the anisotropic layer
g) repeating steps a) through f) coating over the polymerized anisotoropic layer of f) but photo-aligning the orientation layer at a predetermined angle to the direction in step c).

26. The process of claim 25 wherein the predetermined angle of step g) to the dirction in step c) is 90°.

27. A continuous process for making an optical compensator on a support web, comprising the steps of:
a) coating an orientation layer comprising a photo-alignable polymer in an organic solvent over the support;
b) drying the orientation layer;
c) photoaligning the orientation layer in a predetermined direction relative to the web moving direction;
d) coating an anisotropic layer comprising a polymerizable material and a surfactant compound in a solvent carrier onto the orientation layer;
e) drying the anisotropic layer;
f) polymerizing the anisotropic layer to form a first continuous web of a multilayer integral component;
g) repeating the above steps a) through f) coating over the anisotropic layer obtained from e) but photo-aligning the orientation layer at a predetermined angle to the direction in step c).

28. The process of claim 27 wherein the predetermined angle of step i) to the direction in step c) is 90°.

29. The process of claim 27 wherein the anisotropic coating contains 0.001 to 0.1 wt % of the surfactant.

30. The process of claim 29 wherein the surfactant is present in an amount of from 0.01 to 0.05 wt % of the liquid crystal coating material as applied.

31. The process of claim 27 wherein the surfactant comprises a moiety selected from fluoride, silicone, polyalkylene oxide, fatty acid salts and esters.

32. The process of claim 27 wherein the surfactant comprises a moiety selected from fluoride and silicone.

33. The process of claim 27 wherein the surfactant comprises a fluorinated surfactant.

34. The process of claim 27 wherein the fluorinated surfactant comprises a perfluorinated alkylene segment.
